(19) United States
(12) Patent Application Publication
(10) Pub. No.: US 2023/0330952 A1
(43) Pub. Date: Oct. 19, 2023

(54) METHOD OF MANUFACTURING A FIBRE REINFORCED COMPOSITE COMPONENT HAVING A REINFORCED HOLE

(71) Applicant: Aalborg Universitet, Aalborg Øst (DK)

(72) Inventors: Benny Ørtoft Endelt, Dronninglund (DK); Johnny Jakobsen, Klarup (DK)

(21) Appl. No.: 18/025,793

(22) PCT Filed: Sep. 13, 2021
(86) PCT No.: PCT/DK2021/050280

§ 371 Date: Mar. 10, 2023

(30) Foreign Application Priority Data
Sep. 14, 2020 (DK) PA 2020 70590

(51) Int. Cl. B29C 70/68; B29C 70/70

(52) U.S. Cl. CPC B29C 70/682; B29C 70/70

(57) ABSTRACT

The invention relates to a method of manufacturing a composite component with continuous fibre reinforcement and having a reinforced hole. The hole is reinforced by incorporation of at least one reinforcing element (1) into a layered arrangement of continuous fibres. The reinforcing element comprises a circumferential member (2) with a through-going first hole (9) and a plurality of continuous element fibres (3). The at least one reinforcing element (1) is arranged in an overlapping and/or sandwiching engagement with the layered arrangement so that the first hole is arranged within and aligned with a second hole (8) to be reinforced. Hereby an externally force applied to the reinforced hole during use of the component is distributed over a larger region of the material around the hole. Thereby the component can be joined to another part e.g. by a bolted connection which allows for disassembly that would not have been possible if they were joined by adhesive joining.

### FIELD OF THE INVENTION

The present invention relates to a method of manufacturing a composite component with continuous fibre reinforcement and having a hole to be used e.g. for joining the component with another component. In particular, it relates to such a component in which the hole is reinforced in such a way that localized forces applied to the hole are distributed to a region around the hole.

### BACKGROUND OF THE INVENTION

Fibre composite materials are used in many applications including for sports gear, cars, boats, wind turbine blades etc. These materials have a unique performance when it comes to lightweight load-carrying structural components as the material can be tailored to specific needs. However, beside their superior mechanical performance, they perform weakly when concentrated loads are to be introduced. Therefore, adhesive bonding is the preferred joining technique as the load can hereby be transferred over a larger area. Unfortunately, this method of joining limits e.g. the ability to substitute worn out components with new ones, and costly local repairs are therefore often performed to extend the lifetime of the structure.

An alternative is to use joining by bolt or rivet connections. This allows for some disassembly, but it requires excessive composite material to secure a sufficient load introduction. Such excessive amount of material is disadvantageous due to the added weight and volume as well as added cost. Furthermore, if the holes for the assembly are obtained by drilling, there is a risk of introducing damage and weak points in the material during the drilling.

### OBJECT OF THE INVENTION

It is an object of the present invention to provide a method of manufacturing a fibre-reinforced component with which it is prepared for assembly with another component in a way that allows for disassembly without damaging the component.

It is another object of the present invention to provide a method of manufacturing a fibre-reinforced component with which it is prepared for assembly with another component in a way that allows for a higher load carrying capacity for a given amount of material than with known methods of joining.

It is another object of the present invention to provide a method of manufacturing a fibre-reinforced component with which it is prepared for assembly with another component in a way that lowers the risk of failure of the component due to damage induced during the joining than with known methods of joining. Such damage could e.g. be induced with a known method requiring drilling of holes to be joined with bolts.

It is an object of at least some embodiments of the invention to provide a method of manufacturing a fibre-reinforced component with which it is prepared for assembly with another component in a way which is more reliable and/or more efficient than with known methods of joining.

It is a further object of the present invention to provide an alternative to the prior art.

In particular, it may be seen as an object of the present invention to provide a method of manufacturing a fibre reinforced composite component that solves the above mentioned problems of the prior art.

### SUMMARY OF THE INVENTION

Thus, the above described object and several other objects are intended to be obtained in a first aspect of the invention by providing a method of manufacturing a composite component with continuous fibre reinforcement and having a reinforced hole, the method comprising:
providing at least one reinforcing element comprising:
   a circumferential member with a through-going first hole, and
   a plurality of continuous element fibres extending away from the circumferential member while being in engagement with the circumferential member,
providing a layered arrangement of the continuous fibre reinforcement, the arrangement comprising a second hole to be reinforced by the reinforcing element, the second hole extending through the layered arrangement and having a shape matching the shape of the circumferential member,
   wherein the at least one reinforcing element is arranged with the first hole being arranged within and aligned with the second hole, and
   wherein the element fibres are arranged in an overlapping and/or sandwiching engagement with the layered arrangement of the continuous fibre reinforcement over a region around the first and second holes, and
   if the fibres are dry, impregnating them with matrix material and solidifying the matrix material, or
   if the fibres are pre-impregnated with matrix, solidifying the matrix material.

The reinforced hole in the composite component being manufactured will typically be circular. However, other shapes, such as elliptical, oblong, or rectangular, are also covered by the scope of protection. The first and second holes will typically have the same geometrical shape, such as circular or elliptical, but in principle it will also be able to use a reinforcing member with a circumferential member having e.g. a circular first hole and an elliptical outer shape matching an elliptical second hole in the layered arrangement of the continuous reinforcement.

By “in engagement with”, in relation to the mutual arrangement of the element fibres and the circumferential member, is preferably meant that a force applied to the circumferential member can be transferred to the element fibres due to the engagement. At the time when the reinforcing element has still not been arranged in the position of use, the engagement may mainly be based on frictional forces or on the respective geometrical designs of the circumferential member and the element fibres. The element fibres can e.g. be arranged within the first hole in the circumferential member so that in the manufactured component, the element fibres are arranged through the first hole in the circumferential member while having the element fibres extending away from the first hole in the circumferential member; examples will be shown in the figures. However, the element fibres may also be arranged in further holes or slits provided in the circumferential member. Such arrangements imply that the reinforcing element can be prepared beforehand as a ready-to-use element which facilitates the manufacturing process compared to a process in which fibres used to reinforce a hole are to be arranged, e.g. as individual strands, during the manufacturing of the composite component. Thus, the use of a reinforcing element as in the present invention may result in a more efficient and reliable manufacturing process.

The word “element” in relation to “element fibres” is used because these fibres are related to the reinforcing element and to distinguish them from the continuous fibres forming part of the surrounding composite material.

By “sandwiching engagement” is preferably meant that the element fibres are arranged with at least one layer of the continuous reinforcement on each side thereof. Examples will be shown in the figures.

By such a manufacturing method, it is possible to obtain a composite component that can be joined to e.g. another component via the hole in a manner that forms a stronger and more fatigue resistant connection than without such reinforcement of the hole and thereby contribute to a more reliable and fail safe connection/joint. This is because external forces applied to the hole, typically locally, can be distributed over a larger region of the composite component thereby lowering the risk of local stresses exceeding a critical value. This is even more the case because a compressive and local stress is transferred into a tensile stress, and fibres used for composite materials typically have a larger tensile strength compared to their compressive strength.

The element fibres may e.g. extend radially away from a central axis of the hole. However, for some applications and loading situations, it may also be relevant to let the element fibres extend e.g. tangentially to the circumference of the hole as that would be more advantageous for taking-up in-plane torsional loading of the component during use.

Another advantage of the invention is that by reinforcing the hole by use of a reinforcing element designed and incorporated for that purpose, the other fibre reinforcement of the component can be optimised with respect to other forces to be carried during use of the component, as this other fibre reinforcement no longer needs to be arranged in a manner related to the transfer of forces from the hole.

A composite component manufactured in accordance with the present invention may e.g. find use in relation to wind turbine blades, such as for root end to hub reinforcement and for joining of blade sections. As an example, the possibility of using wind turbine blades that are made from more parts that can be assembled and used without compromising the strength requirements will make it easier to transport the blades to the site of use before assembly.

Within the car industry, components made in accordance with the invention may e.g. be used when there is a need for the joining of various metallic parts, such as suspension, bumper, motor, and seats, to a composite monocoque part. In fact, the invention is considered useful within a large number of industries including for the boat, train, and aviation industries.

In some embodiments of the invention, the element fibres are provided in a configuration selected from bundle, band, and/or stretchable sleeve. When they are provided as bundles or bands, these will typically be arranged at different parts of the circumferential members so that they extend in different directions. They may be evenly distributed around the circumferential member. Alternatively, more fibres may be arranged at some points than at others depending on an expected loading of the reinforced hole during use. The element fibres may also be provided as two or more stretchable sleeves arranged inside each other as will be shown in the figures. A stretchable sleeve typically comprises fibres that are connected, such as interwoven, in a loose and thereby stretchable tubular configuration. The connection, such as interweaving, provides some mutual support to the fibres whereby it may be easier to arrange and keep them in the desired positions until they are fixated by the solidified matrix. A further advantage of a sleeve is that it can hereby be easier to ensure an even distribution of the element fibres, so that an applied outer force can be redistributed into a larger region around the hole. The magnitude of stress concentrations from the external force will then be lowered due to the redistribution obtained by the element fibers.

The layered arrangement of the continuous fibre reinforcement may be provided by a winding process, a fibre placement process, or a tape laying process. In a winding process, the fibres are typically wound around a rotating mandrel. In such embodiments, a part of the wound fibres is considered as a layer even though it has been arranged over a period of time and not as a separate unit as would be the case for a fibre mat.

Alternatively, the layered arrangement of the continuous fibre reinforcement may be provided by stacking of fibre mats. Such fibre mats could be provided as dry mats or as pre-impregnated mats. They would typically be arranged in a mould for the provision of the outer shape of the component. The arrangement of the fibre mats can be performed manually or by an automated or semi-automated process.

In embodiments of the invention, wherein the layered arrangement of the continuous fibre reinforcement is provided by stacking of fibre mats, the method may further comprise the following steps:
providing a plurality of fibre mats in the form of at least one first, at least one second, and at least one third fibre mats, each fibre mat being provided with a hole arranged to form part of a coherent second hole through the laminate after stacking of the fibre mats,
providing the reinforcing element as comprising a stretchable sleeve of continuous fibres, the sleeve being arranged extending through the first hole in the circumferential member,
placing the at least one first fibre mat on a work surface,
spreading the first part of the sleeve to extend away from the first hole in the circumferential member,
arranging the reinforcing element with the first hole aligned with the second hole of the at least one first fibre mat and so that the first part of the sleeve extends along the at least one first fibre mat over a region around the first and second holes,
passing the second part of the sleeve through the second hole in the at least one second fibre mat and arranging the at least one second fibre mat on the at least one first fibre mat so that the first part of the sleeve is sandwiched between the at least one first fibre mat and the at least one second fibre mat,
spreading the second part of the sleeve to extend away from the circumferential member so that the second part of the sleeve extends along the at least one second fibre mat over a region around the first and second holes, and
arranging the at least one-third fibre mat on the at least one second fibre mat so that the second part of the sleeve is sandwiched between the at least one second fibre mat and the at least one-third fibre mat, the arrangements being so that the holes in all the fibre mats are aligned.

As an alternative to such a method, the stacking process may be so that element fibres are arranged at the surface of the final component. It is also possible to have the first and second parts of the element fibres arranged next to each other, i.e. without fibre mats there between.

Alternatively to what has been described above, the first aspect of the invention may be obtained by providing a method of manufacturing a composite component with continuous fibre reinforcement and having a reinforced hole, the method comprising the following steps:
providing a reinforcing element comprising a circumferential member with a through-going first hole,
providing a plurality of fibre mats in the form of at least one first and at least one second fibre mats, each fibre mat being provided with a second hole arranged to form part of a coherent second hole through the laminate after stacking of the fibre mats, the second hole having a shape matching the shape of the circumferential member,
placing the at least one first fibre mat on a work surface,
arranging the reinforcing element with the first hole aligned with the second hole of the at least one fibre mat,
arranging the at least one second fibre mat on the at least one first fibre mat with the second holes aligned,
using tailored fibre placement to arrange continuous fibre reinforcement in a predetermined pattern over a region around the first and second holes so that forces can be transferred from the circumferential member and to a surrounding region of the component during later use of the component, and
   if the fibres are dry, impregnating them with matrix material and solidifying the matrix material, or
   if the fibres are pre-impregnated with matrix, solidifying the matrix material.

By “tailored fibre placement” is meant a textile manufacturing technique based on the principle of sewing, knitting or crochet for a continuous placement of fibrous material for composite components. The fibrous material is fixed with an upper and lower stitching thread on a base material, which in this case is the arrangement of fibre mats. By such a process, a part of the continuous fibre reinforcement can be placed near net-shape in curvilinear patterns upon a base material in order to create stress adapted composite components.

Such a way of performing the invention is mainly relevant in relation to methods wherein the layered arrangement of the continuous fibre reinforcement is provided by stacking of fibre mats, since the tailored fibre placement is typically provided in a manner that is not appropriate to combine with the presence of a mandrel as is normally used for the winding process.

The step of arranging the at least one second fibre mat on the at least one first fibre mat with the second holes aligned may be performed so that the circumferential member of the reinforcing element is sandwiched between the fibre mats.

In any of the embodiments as described above, the circumferential member may be a solid ring. Alternatively, the circumferential member can e.g. be continuous fibres wound around the element fibres. At least for some embodiments, a solid ring, such as a metal ring, will facilitate the arrangement of the continuous fibre reinforcement. In the case of fibre mats provided with second holes, they can be arranged around the solid ring which will ensure that they stay aligned throughout the manufacturing process. A solid ring is also considered to be more suitable for ensuring an even distribution of the forces applied during use. Furthermore, a metal ring can be used to improve the fatigue strength, if it is made in a material with sufficiently high fracture toughness to suppress any fatigue crack growth. The fatigue properties may be further improved by using a ring with low surface roughness. Furthermore, a well-defined interface between the bolt to be used for the joining and the rim of the hole minimizes the risk of crushing the laminate due to local high contact pressure or wear, or due to friction between the bolt and the laminate, i.e. adhesive wear due to sliding.

The method may further comprise using a guide mandrel to keep the second holes of the layered arrangement of continuous fibre reinforcement and the first hole of the at least one reinforcing element aligned during the manufacturing. The circumferential member will then be arranged in alignment with the guide mandrel as will be shown in the figures. What is here referred to as “guide mandrel” could be an element that is to remain in place as part of the final component. It could e.g. be a shaft, a bearing, or a tube. Alternatively, the guide mandrel could be removed after the solidification of the matrix material.

When a guide mandrel is used, the circumferential member may be in the form of continuous fibres wound several times around the guide mandrel, e.g. around a sleeve of element fibres.

In any of the embodiments as mentioned above, the reinforcing element may further be provided with a circumferential insert having an inner surface forming the edge of the reinforced hole and an outer surface for supporting the circumferential member. Hereby it will be easy to ensure that a required dimensional tolerance of the hole is obtained as that will be determined by the insert. It will also be a good way to ensure that the reinforced hole has a smooth surface which can improve the fatigue performance of the composite component, as it can be less prone to crack initiation caused by loading being applied to the surface of the hole, i.e. the inner surface of the insert, during use of the composite component.

The outer surface of the circumferential insert may e.g. have a recess adapted to receive and hold the circumferential member in place. Hereby it will be easier to keep the different parts aligned in the correct mutual positions during the manufacturing process. An example of a possible design will be shown in the figures.

In embodiments having a circumferential insert, it may be provided as two halves which are inserted from opposite sides of the reinforced hole being formed and joined to form a subsequently coherent insert. At least for some geometries that may facilitate the arrangement of the insert.

At least for some of the embodiments mentioned above, the method may further comprise the step of stitching the element fibres and the fibres of the continuous fibre reinforcement made by tailored fibre placement together after all the fibres and the reinforcement have been arranged. Hereby the risk of delamination can be lowered.

In any of the embodiments as described above, a stack of reinforcing elements may be used for the provision of the reinforced hole. This may be particularly relevant for components having large thicknesses.

A second aspect of the invention relates to a composite component being manufactured by any of the embodiments of the invention according to the first aspect of the invention.

A third aspect of the invention relates to a reinforcing element for use in a method according to the first aspect of the invention, the reinforcing element comprising:
a circumferential member with a through-going first hole, and
a plurality of continuous element fibres with a first and a second part of the element fibres extending in opposite directions away from the circumferential member while being in engagement with the circumferential member.

In such a reinforcing element, the circumferential member may be a solid ring, and the reinforcing element may further comprise a circumferential insert having an inner surface adapted to form an edge of a hole to be reinforced by the reinforcing element and an outer surface for supporting the circumferential member. Such a circumferential insert may e.g. be made from metal or polymer.

In a reinforcing element comprising a circumferential insert, the outer surface of the circumferential insert may have a recess adapted to receive and hold the circumferential member in place.

The first, second and third aspects of the present invention may each be combined with any of the other aspects. Furthermore, the two overall different ways of performing a method according to the first aspect of the invention can also be combined. In such a combining method, first at least one reinforcing element comprising element fibres is arranged in engagement with a stack of fibre mats. Then additional reinforcement is arranged by use of tailored fibre placement to provide further routes for the transfer of stresses from the hole into the surrounding material.

These and other aspects of the invention will be apparent from and elucidated with reference to the embodiments described hereinafter.

### BRIEF DESCRIPTION OF THE FIGURES

The method of manufacturing a composite component according to the invention as well as a reinforcing element for use in such a method will now be described in more detail with regard to the accompanying figures. The figures show one way of implementing the present invention and is not to be construed as being limiting to other possible embodiments falling within the scope of the attached claim set.

FIG. 1 schematically shows the overall idea of reinforcing a hole in a composite component in order to distribute a concentrated load to a larger area around the hole.

FIGS. 2A to 2D schematically show different examples of a reinforcing element.

FIGS. 3A to 3C schematically show an embodiment of the invention comprising providing the layered arrangement of the continuous fibre reinforcement by stacking of fibre mats.

FIG. 4 schematically shows an alternative embodiment of the invention comprising providing the layered arrangement of the continuous fibre reinforcement by winding.

FIGS. 5A and 5B schematically show an embodiment of the invention in which the continuous fibre reinforcement is provided as fibre mats in combination with tailored fibre placement.

FIG. 6 schematically shows embodiments of the invention comprising the use of a guide mandrel. FIG. 6A shows the use of a guide mandrel to keep the holes aligned, and FIG. 6B shows how the circumferential member of the reinforcing element can be obtained by winding continuous fibres around a guide mandrel.

FIGS. 7A-7D schematically show different embodiments of the invention in which a stack of reinforcing elements is used.

FIG. 8 shows experimental results from a comparison between components having a reinforced hole and an un-reinforced hole, respectively.

FIGS. 9A and 9B show results from computer simulations.

### DETAILED DESCRIPTION OF AN EMBODIMENT

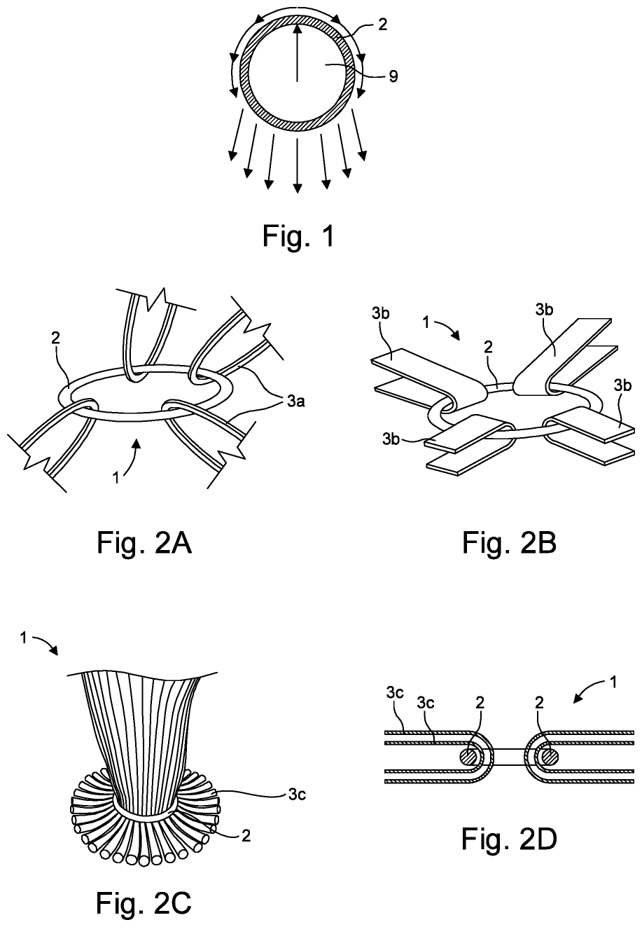

As described above, the present invention relates to a composite component with continuous fibre reinforcement and having a hole to be used e.g. for the assembly of the component with another component. During use of the component, many kinds of loading situations can give rise to a concentrated loading on the edge of the hole. Due to the inner structure of the composite material, such concentrated loading may cause damage, such as delamination or crack growth. FIG. 1 schematically shows the overall idea of the present invention, namely to use a design with which the outer localized force is transferred into a larger region of the material surrounding the hole so that the resulting stresses can hereby be kept below a critical level. In FIG. 1, the upwardly pointing arrow is the applied external force, and the other arrows show the distribution of this force into the surrounding material. This spreading out of the loading by arranging continuous fibres extending from the hole and into the surrounding material will be explained in the following.

The method includes incorporating at least one reinforcing element into the component in order to obtain a reinforced hole. In some embodiments of the invention, such a reinforcing element comprises a circumferential member with a through-going first hole and a plurality of continuous element fibres extending away from the circumferential member while being in engagement with the circumferential member. FIG. 2 schematically shows different examples of such a reinforcing element 1. In the examples, the circumferential member 2 is provided in the form of a solid ring which may e.g. be made from metal, polymer or composite material. FIG. 2A shows the element fibres 3 in the form of bundles 3a of fibres arranged evenly with respect to the circumferential member 2. However, it will also be possible e.g. to use more fibres along some orientations than along others to obtain an optimal stress pattern during the subsequent use of the component. FIG. 2B shows the element fibres in the form of bands 3b of element fibres, and FIG. 2C shows the element fibres in the form of a stretchable sleeve 3c. Such a stretchable sleeve 3c is typically provided as woven fibres in a tubular configuration and should be loose enough to allow for the two parts thereof being stretchable into a configuration of use, wherein they typically extend radially away from the circumferential member 2. In the figure, the fibres are shown as extending parallel to each other before being spread out for ease of illustration only. In practise, they will typically be interwoven or held together by stitching. It will also be possible to use two or more sleeves 3c arranged inside each other as shown schematically in FIG. 2D.

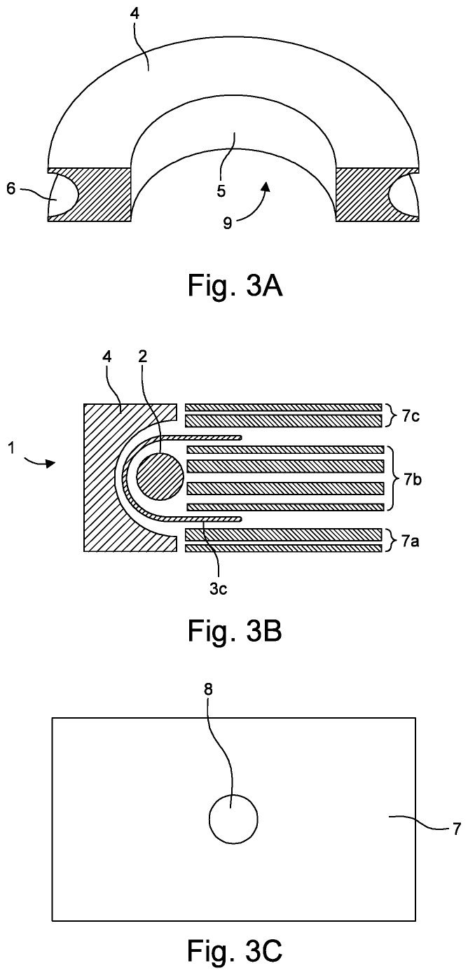

FIG. 3 schematically shows an embodiment, wherein the reinforcing element 1 is further provided with a circumferential insert 4 having an inner surface 5 forming the edge of the reinforced hole and an outer surface 6 for supporting the circumferential member 2. FIG. 3A shows a three-dimensional cross-sectional view through the circumferential insert 4, and FIG. 3B shows a cross-sectional view through the region around the right half of the circumferential insert 4. The layers and other component are shown separated to ease the view. In this illustrated embodiment, the outer surface 6 of the circumferential insert 4 has a recess adapted to receive and hold the circumferential member 2 in place in particular during the manufacturing but also during the subsequent use of the component being manufactured. FIG. 3C is a top view of a fibre mat 7 with a second hole 8 to be reinforced, the fibre mat to be arranged in a stack of other fibre mats. In FIG. 3, the circumferential insert 4 is shown as one unit, but it may also be provided as two halves which are inserted from opposite sides of the reinforced hole being formed and joined to form a subsequently coherent insert.

A method of manufacturing a composite component with a reinforced hole will now be described with reference to the features shown in FIG. 3. The method comprises providing a layered arrangement of the continuous fibre reinforcement, e.g. in the form of stacked fibre mats 7. The arrangement comprises a second hole 8 to be reinforced by the reinforcing element 1, the second hole 8 extending through the layered arrangement and having a shape matching the shape of the circumferential member 2. The circumferential member 2 has a through-going first hole 9; see FIG. 1. In FIG. 3, only one reinforcing element 1 is used, but as will be explained below, it is also possible to use more than one reinforcing element for a given hole. The reinforcing element 1 is arranged with the first hole 9 being arranged within and aligned with the second hole 8. In the embodiment in FIG. 3, the element fibres 3c in the form of a sleeve are arranged in an overlapping and sandwiching engagement with the layered arrangement of the continuous fibre reinforcement of the fibre mats 7 over a region around the first and second holes 8,9. The fibre mats 7 may be identical, but they may also differ with respect to fibre orientation and possibly also type of fibres. Which lay up of fibres to use will be determined as part of the design process and may e.g. be done by use of computer simulations as will be well known to a person skilled in the art. If the fibres are dry, the lay-up process is followed by impregnating them with matrix material, typically a polymer. This can e.g. be done in a closed mould by use of vacuum to drive the polymer into the voids between the fibres; then the matrix material is solidified. If the fibres are pre-impregnated with matrix, the lay-up is followed by a process of solidifying the matrix material, typically by heating. This process may also include the use of vacuum to remove air bubbles from the not yet solidified matrix and thereby limit the amount of voids in the final component.

The method as shown in FIG. 3 comprises the following steps:
providing eight fibre mats 7 in the form of two first fibre mats 7a, four second fibre mats 7b, and two third fibre mats 7c, each fibre mat 7 being provided with a hole arranged to form part of a coherent second hole 8 through the laminate after stacking of the fibre mats 7,
providing the reinforcing element 1 as comprising a stretchable sleeve 3c of continuous fibres, the sleeve 3c being arranged extending through the first hole 9 in the circumferential member 2,
placing the two first fibre mats 7a on a work surface,
spreading the first part of the sleeve 3c to extend away from the first hole 9 in the circumferential member 2,
arranging the reinforcing element 1 with the first hole 9 aligned with the second hole 8 of the two first fibre mats 7a and so that the first part of the sleeve 3c extends along the uppermost of the first fibre mats 7a over a region around the first and second holes 8,9,
passing the second part of the sleeve 3c through the second hole 8 in the four second fibre mats 7b and arranging the four second fibre mats 7b on the two first fibre mats 7a so that the first part of the sleeve 3c is sandwiched between the uppermost of the first fibre mats 7a and the lowermost of the second fibre mat 7b,
spreading the second part of the sleeve 3c to extend away from the circumferential member 2 so that the second part of the sleeve 3c extends along the uppermost second fibre mat 7b over a region around the first and second holes 8,9,
arranging the two third fibre mats 7c on the second fibre mats 7b so that the second part of the sleeve 3c is sandwiched between the uppermost second fibre mat 7b and the lowermost third fibre mat 7c, the arrangements being so that the second holes 8 in all the fibre mats 7 are aligned.

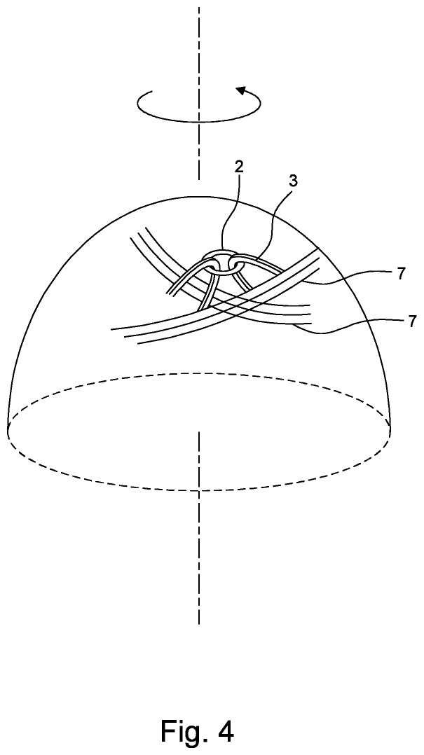

FIG. 4 schematically shows an alternative way of arranging the layered arrangement of the continuous fibre reinforcement 7, namely by a winding process. In such a process, some winding is performed before the process is typically temporarily interrupted to allow for the arrangement of a first part of the element fibres 3. Then the winding is continued for the establishment of further continuous reinforcement and temporarily interrupted again for the arrangement of the second part of the element fibres 3.

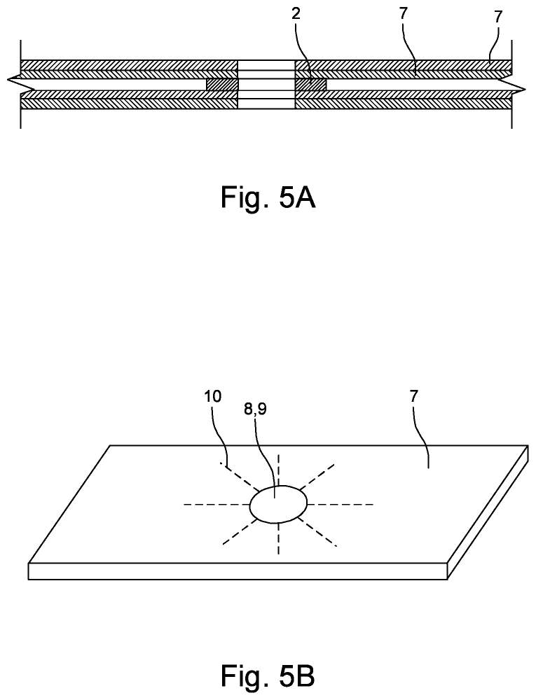

An alternative to the above-described incorporation of a reinforcing element 1 comprising element fibres 3 is schematically shown in FIG. 5. In such a method, the reinforcing element 1 typically only comprises a circumferential member 2 with a through-going first hole 9. A stack of fibre mats 7 is then arranged on a work surface, each fibre mat being provided with a second hole 8 arranged to form part of a coherent second hole 8 through the laminate after stacking of the fibre mats 7. The second hole 8 has a shape matching the shape of the circumferential member 2. After the fibre mats 7 and the circumferential member 2 have been arranged as shown in FIG. 5A, tailored fibre placement is used to arrange continuous fibre reinforcement 10 in a predetermined pattern over a region around the first and second holes 8,9 as shown in FIG. 5B. The fibres being arranged by the tailored fibre placement correspond to the element fibres 3 as described above. Hereby it is obtained that forces can be transferred from the circumferential member 2 and to a surrounding region of the component during later use of the composite component. The subsequent method steps resemble those described for the methods above.

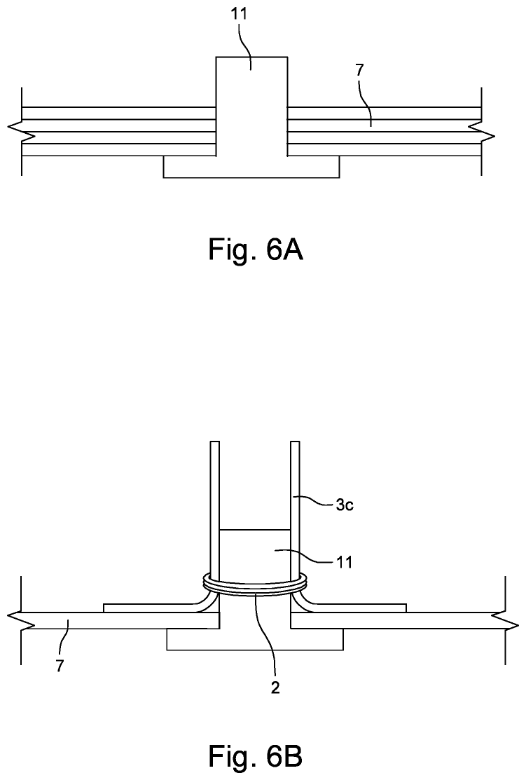

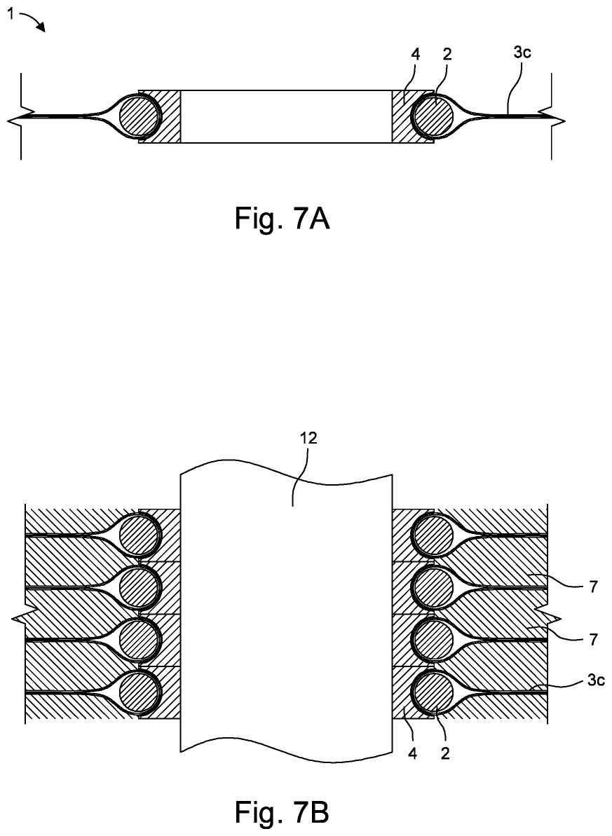

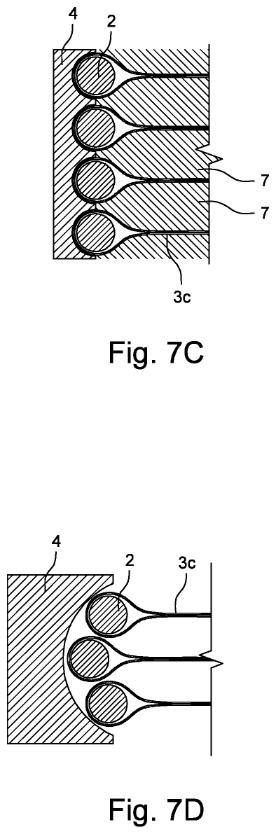

In any of the methods as described above, the arrangement of the continuous fibres 7 may include the use a guide mandrel 11 to keep the second holes 8 of the layered arrangement of continuous fibre reinforcement 7 and the first hole 9 of the at least one reinforcing element 1 aligned during the manufacturing whereby better tolerances can be obtained. An example of the use of such a guide mandrel 11 is shown schematically in FIG. 6A. Such a guide mandrel 11 can also be used to provide the circumferential member 2 of the reinforcing element 1 in the form of continuous fibres wound several times around the guide mandrel 11 as an alternative to using a solid ring. This is shown schematically in FIG. 6B. See also the following description of FIG. 7.

As mentioned above, it will be possible to use a stack of reinforcing elements 1 for the provision of the reinforced hole. FIG. 7 shows different examples of such embodiments. FIG. 7A shows one reinforcing element 1 comprising a circumferential insert 4 and the circumferential member 2 in the form of wound fibres. FIG. 7B shows how a stack of four of the reinforcing elements 1 in FIG. 7A are arranged in a stack. In this embodiment, the reinforcing elements 1 are arranged around another element 12 that is to remain in place as part of the final component; it could e.g. be a shaft. However, a mandrel used during the arrangement of the different materials and to be removed afterwards would look the same. During such a stacking, the circumferential inserts 4 are typically arranged as the building-up of the laminate structure goes along. In embodiments wherein a plurality of circumferential inserts 4 are arranged on top of each other, they may be provided with mutually matching shapes that prevent them from sliding sideways. Hereby it is possible to obtain an engagement which ensures that they remain aligned. FIG. 7B also illustrates that the element fibres 3 of the reinforcing elements 1 can be arranged adjacent to each other without e.g. having any fibre mats 7 arranged there between. The number of reinforcing elements 1 as well as the arrangements of the different layers of fibre mats will be determined during the design of a composite component for a given application. Such a design process will typically include both computer simulations and experimentation. FIG. 7C shows an embodiment in which the outer surface 6 of the circumferential insert 4 is provided with four recesses each designed for holding a circumferential member 2 and a corresponding sleeve 3c of element fibres in the desired position. FIG. 7D shows an embodiment in which three circumferential members 2 and three corresponding sleeves 3c of element fibres are arranged in one recess of a circumferential insert 4.

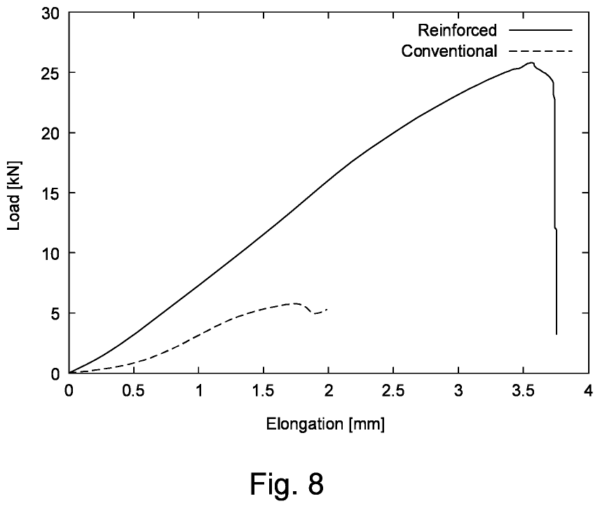

FIG. 8 shows experimental results from a comparison between comparable components having a reinforced hole and an un-reinforced hole, respectively. The loading was uniaxial tensile testing. As seen from the figure, the method according to the invention can be used to provide a significant improvement of a composite component having a hole to be used e.g. for the assembly with another component.

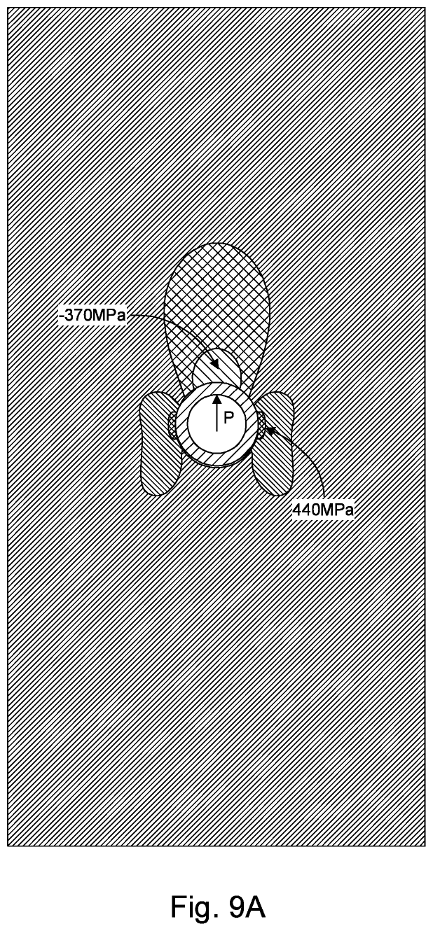

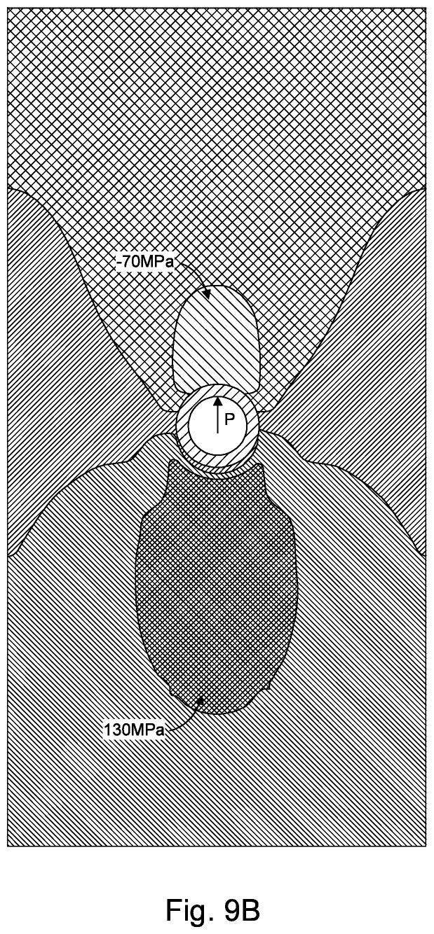

FIG. 9 shows results from computer simulations. FIGS. 9A and 9B illustrate the difference between a conventional and a reinforced hole, as shown in FIGS. 9A and 9B, respectively. The results are generated using a finite element model of an 8-layer laminate forming an isotropic laminate, and the reinforcing element is placed between layer 4 and 5. The model also includes a circumferential insert in the form of a metal ring which serves as an interface between the mandrel and the laminate. The only difference between the two models is the reinforcing element which is removed when simulating the conventional method. The FIGS. 9A and 9B show the stress in the loading direction at the top layer (outer surface). The conventional hole shows significant compressive stress concentrations above the hole of −370 MPa representing a small area carrying the majority of the load, see FIG. 9A. Compared with FIG. 9B where the compressive stresses are reduced by a factor 5 to −70 MPa for the reinforced hole;

the load-carrying area is now located below the hole, and the stresses are reduced and distributed over a larger area. Thus, the stresses are well below the ultimate stress which is in the range of 280 MPa for the current laminate. These findings are also supported by the experimental data in FIG. 8, where the maximum load for the conventional design was in the range of 5 kN versus 25 kN for the reinforced hole.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Furthermore, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. Method of manufacturing a composite component with continuous fibre reinforcement and having a reinforced hole, the method comprising:
providing at least one reinforcing element comprising:
a circumferential member with a through-going first hole, and
a plurality of continuous element fibres extending away from the circumferential member while being in engagement with the circumferential member,
providing a layered arrangement of the continuous fibre reinforcement, the arrangement comprising a second hole to be reinforced by the reinforcing element, the second hole extending through the layered arrangement and having a shape matching the shape of the circumferential member,
wherein the at least one reinforcing element is arranged with the first hole being arranged within and aligned with the second hole, and
wherein the element fibres are arranged in an overlapping and/or sandwiching engagement with the layered arrangement of the continuous fibre reinforcement over a region around the first and second holes, and
if the fibres are dry, impregnating them with matrix material and solidifying the matrix material, or
if the fibres are pre-impregnated with matrix, solidifying the matrix material.

2. Method according to claim 1, wherein the element fibres are provided in a configuration selected from bundle, band, and/or stretchable sleeve.

3. Method according to claim 1, wherein the layered arrangement of the continuous fibre reinforcement is provided by a winding process, a fibre placement process, or a tape laying process.

4. Method according to claim 1, wherein the layered arrangement of the continuous fibre reinforcement is provided by stacking of fibre mats.

5. Method according to claim 4, the method further comprising the following steps:
providing a plurality of fibre mats in the form of at least one first, at least one second, and at least one third fibre mats, each fibre mat being provided with a hole arranged to form part of a coherent second hole through the laminate after stacking of the fibre mats,
providing the reinforcing element as comprising a stretchable sleeve of continuous fibres, the sleeve being arranged extending through the first hole in the circumferential member,
placing the at least one first fibre mat on a work surface,
spreading the first part of the sleeve to extend away from the first hole in the circumferential member,
arranging the reinforcing element with the first hole aligned with the second hole of the at least one first fibre mat and so that the first part of the sleeve extends along the at least one first fibre mat over a region around the first and second holes,
passing the second part of the sleeve through the second hole in the at least one second fibre mat and arranging the at least one second fibre mat on the at least one first fibre mat so that the first part of the sleeve is sandwiched between the at least one first fibre mat and the at least one second fibre mat,
spreading the second part of the sleeve to extend away from the circumferential member so that the second part of the sleeve extends along the at least one second fibre mat over a region around the first and second holes,
arranging the at least one third fibre mat on the at least one second fibre mat so that the second part of the sleeve is sandwiched between the at least one second fibre mat and the at least one third fibre mat, the arrangements being so that the holes in all the fibre mats are aligned.

6. Method of manufacturing a composite component with continuous fibre reinforcement and having a reinforced hole, the method comprising the following steps:
providing a reinforcing element comprising a circumferential member with a through-going first hole,
providing a plurality of fibre mats in the form of at least one first and at least one second fibre mats, each fibre mat being provided with a second hole arranged to form part of a coherent second hole through the laminate after stacking of the fibre mats, the second hole having a shape matching the shape of the circumferential member,
placing the at least one first fibre mat on a work surface,
arranging the reinforcing element with the first hole aligned with the second hole of the at least one fibre mat,
arranging the at least one second fibre mat on the at least one first fibre mat with the second holes aligned,
using tailored fibre placement to arrange continuous fibre reinforcement in a predetermined pattern over a region around the first and second holes so that forces can be transferred from the circumferential member and to a surrounding region of the component during later use of the component, and
if the fibres are dry, impregnating them with matrix material and solidifying the matrix material, or
if the fibres are pre-impregnated with matrix, solidifying the matrix material.

7. Method according to claim 1, wherein the circumferential member is a solid ring.

8. Method according to claim 1, wherein the method further comprises using a guide mandrel to keep the second holes of the layered arrangement of continuous fibre reinforcement and the first hole of the at least one reinforcing element aligned during the manufacturing.

9. Method according to claim 8, wherein the circumferential member is in the form of continuous fibres wound several times around the guide mandrel.

10. Method according to claim 1, wherein the reinforcing element is further provided with a circumferential insert having an inner surface forming the edge of the reinforced hole and an outer surface for supporting the circumferential member.

11. Method according to claim 10, wherein the outer surface of the circumferential insert has a recess adapted to receive and hold the circumferential member in place.

12. Method according to claim 10, wherein the circumferential insert is provided as two halves which are inserted from opposite sides of the reinforced hole being formed and joined to form a subsequently coherent insert.

13. Method according to claim 1, wherein a stack of reinforcing elements is used for the provision of the reinforced hole.

14. (canceled)

15. Reinforcing element for use in a method according to claim 1, the reinforcing element comprising:
a circumferential member with a through-going first hole, and
a plurality of continuous element fibres with a first and a second part of the element fibres extending in opposite directions away from the circumferential member while being in engagement with the circumferential member.

16. Reinforcing element according to claim 15, wherein the circumferential member is a solid ring, and wherein the reinforcing element further comprises a circumferential insert having an inner surface adapted to form an edge of a hole to be reinforced by the reinforcing element and an outer surface for supporting the circumferential member.

17. Reinforcing element according to claim 16, wherein the outer surface of the circumferential insert has a recess adapted to receive and hold the circumferential member in place.

18. Method according to claim 6, wherein the method further comprises using a guide mandrel to keep the second holes of the layered arrangement of continuous fibre reinforcement and the first hole of the at least one reinforcing element aligned during the manufacturing.

19. Method according to claim 6, wherein the reinforcing element is further provided with a circumferential insert having an inner surface forming the edge of the reinforced hole and an outer surface for supporting the circumferential member.

20. Method according to claim 19, wherein the outer surface of the circumferential insert has a recess adapted to receive and hold the circumferential member in place.

21. Method according to claim 6, wherein a stack of reinforcing elements is used for the provision of the reinforced hole.
